(19) United States
(12) Patent Application Publication
(10) Pub. No.: US 2016/0226355 A1
(43) Pub. Date: Aug. 4, 2016

(54) MAGNETIC INDUCTOR ELECTRIC MOTOR

(71) Applicant: MITSUBISHI ELECTRIC CORPORATION, Chiyoda-ku, Tokyo (JP)

(72) Inventors: Hideaki ARITA, Chiyoda-ku (JP); Akihiro DAIKOKU, Chiyoda-ku (JP); Hirofumi DOI, Chiyoda-ku (JP)

(73) Assignee: MITSUBISHI ELECTRIC CORPORATION, Chiyoda-ku, Tokyo (JP)

(21) Appl. No.: 14/916,197

(22) PCT Filed: Jun. 18, 2014
(86) PCT No.: PCT/JP2014/066139

§ 371 Date: Mar. 3, 2016

(30) Foreign Application Priority Data
Sep. 24, 2013 (JP) 2013-196445

(51) Int. Cl. H02K 16/02; H02K 1/22; H02K 21/44; H02K 1/17

(52) U.S. Cl. CPC H02K 16/02; H02K 1/17; H02K 1/22; H02K 21/44

(57) ABSTRACT

A first stator core and a second stator core are configured by arranging pairs of core blocks into an annular shape, the pairs of core blocks being configured by stacking together core blocks so as to be spaced apart axially, the core blocks including circular arc-shaped core back portions and teeth, permanent magnets are each configured so as to be divided into a plurality of magnet blocks that are held between the pairs of core blocks so as to fit inside the pairs of core blocks, and the magnet blocks include a base portion that is held between the core back portions, and that has an external shape in which two circumferential side surfaces are positioned circumferentially inside two circumferential side surfaces of the core back portions.

### TECHNICAL FIELD

The present invention relates to a magnetic inductor electric motor that is used in applications such as electrically assisted turbochargers that are driven in a high-speed rotational region.

### BACKGROUND ART

Permanent magnet synchronous rotary machines in which magnets that function as a magnetic field means are mounted to a rotor are known conventionally. However, in electric motors that are used in “electrically assisted turbochargers” in which the electric motor is disposed between a turbine and a compressor of an automotive supercharger, since high-speed rotation that exceeds 100,000 revolutions per minute is required, problems with magnet holding strength arise if conventional permanent magnet electric motors are used in these electric motors.

In consideration of these conditions, conventional magnetic inductor rotary machines have been proposed in which magnets that function as a magnetic field means are disposed on a stator, and a rotor is configured such that two rotor cores to which gearwheel-shaped magnetic saliency is applied are disposed so as to be lined up axially so as to be offset circumferentially by a pitch of half a pole (see Patent Literature 1, for example). Because these rotors are constituted only by iron members that have a simple shape, high resistant strength against centrifugal forces is obtained. Thus, conventional magnetic inductor rotary machines are used in applications that require high-speed rotation such as electrically assisted turbochargers, etc.

In conventional magnetic inductor rotary machines, because two rotor cores are disposed so as to line up in an axial direction, twice the axial dimensions are required than in conventional permanent magnet synchronous rotary machines. Thus, when a rotating shaft of the rotor is rotatably supported by bearings that are disposed at two axial ends of the rotor, “axial resonance”, in which the rotating shaft constitutes a resonance system and flexes and vibrates, is more likely to occur. The longer the interval between the bearings, and the faster the rotational speed of the rotor, the more likely that this axial resonance is to arise, and in the worst cases, the rotor will contact the stator.

Restricting the interval between the bearings to increase the rotational speed at which axial resonance arises is effective as a countermeasure to avoid contact between the rotor and the stator during high-speed rotation. Due to constraints of resistant strength against centrifugal forces, rotor diameter is reduced, stator diameter is reduced together therewith, and distance of the coil ends of the stator coil from the central axis of the rotating shaft is shorter. On the other hand, increasing the diameter of the bearings is desirable from the viewpoint of securing rigidity and of securing an oil cooling flow channel, etc. Consequently, if the bearings are disposed radially inside the coil ends of the stator coil, problems of interference between the bearings and the coil ends of the stator coil arise.

Thus, shortening axial length of the coil ends of the stator coil as much as possible is effective in order to avoid interference between the bearings and the coil ends of the stator coil, and reduce spacing between the bearings. In conventional magnetic inductor rotary machines, concentrated winding stator coils are used to shorten the axial length of the coil ends of the stator coil. However, because concentrated winding stator coils are formed by a plurality of concentrated winding coils that are each produced by winding a conductor wire onto a single tooth without spanning over slots, problems arise such as it being hard to mount the concentrated winding coils to a stator core in which teeth are respectively arranged so as to protrude radially inward from an inner circumferential surface of an annular core back so as to be spaced apart from each other circumferentially.

In order to increase the mountability of concentrated winding coils, conventional stator cores have been proposed that are constituted by a plurality of core blocks that include a circular arc-shaped core back portion and a tooth that protrudes radially inward from an inner circumferential surface of the core back portion (see Patent Literature 2, for example). In that configuration, because the stator core can be configured by arranging the core blocks, on the teeth of which concentrated winding coils are mounted, into an annular shape by butting circumferential side surfaces of the core back portions together, mounting of the concentrated winding coils onto the stator core is facilitated.

### CITATION LIST

### Patent Literature

Patent Literature 1: Japanese Patent Laid-Open No. HEI 8-214519 (Gazette)

Patent Literature 2: Japanese Patent Laid-Open No. 2001-103717 (Gazette)

### SUMMARY OF THE INVENTION

### Problem to be Solved by the Invention

In conventional magnetic inductor rotary machines, the two stator cores are housed inside a housing so as to be integrated such that the permanent magnets are held between the core backs and are dispose so as to line up in an axial direction. The permanent magnets are divided in a circumferential direction into a plurality of magnet blocks, but the plurality of magnet blocks are positioned on the stator core, which is a single part, and are fixed by adhesive, etc., and situations such as the magnet blocks contacting each other during assembly of the stator core do not occur.

However, if the technique that is described in Patent Literature 2 is applied, and a stator core for a conventional magnetic inductor rotary machine is configured so as to be divided into a plurality of core blocks in order to increase the mountability of the concentrated winding coils, then core block pairs that are configured by sandwiching a magnet block between two core blocks must be arranged circumferentially and integrated. At that time, the magnet blocks contact each other, and one problem has been that cracking and chipping arises.

The magnet fragments that arise due to cracking or chipping of the magnet blocks may enter a gap between the stator and the rotor and bring about locking of the rotor or increase mechanical loss. Cracking and chipping of the magnet blocks bring about a deterioration in the magnetic characteristics. If the ambient temperature becomes high when the magnetic characteristics of the permanent magnets are greatly reduced, there is also a risk that irreversible demagnetization of the permanent magnets may occur.

The present invention aims to solve the above problems and an object of the present invention is to provide a magnetic inductor electric motor that can eliminate contact among magnet blocks to suppress the occurrence of cracking or chipping of the magnet blocks when core block pairs that hold the magnet blocks are arranged into an annular shape and integrated.

### Means for Solving the Problem

A magnetic inductor electric motor according to the present invention includes: a housing that is produced using a nonmagnetic material; a stator including: a stator core that is configured such that a first stator core and a second stator core that are produced so as to have identical shapes in which teeth that form slots that have openings on an inner circumferential side are disposed at a uniform angular pitch circumferentially so as to project radially inward from an inner circumferential surface of a cylindrical core back are disposed coaxially so as to be separated axially and such that circumferential positions of the teeth are aligned; and a stator coil that is mounted in concentrated windings on respective pairs of the teeth of the stator core that face each other axially, the stator being disposed inside the housing; a rotor in which a first rotor core and a second rotor core that are produced so as to have identical shapes in which salient poles are disposed so as to project at a uniform angular pitch circumferentially on an outer circumferential surface of a cylindrical base portion are fixed coaxially to a rotating shaft so as to be positioned on inner circumferential sides of the first stator core and the second stator core, respectively, and so as to be offset circumferentially by a pitch of half a salient pole from each other, the rotor being disposed rotatably inside the housing; and permanent magnets that are disposed between the first stator core and the second stator core, and that generate field magnetic flux such that the salient poles of the first rotor core and the salient poles of the second rotor core have different polarity. The first stator core and the second stator core are configured by arranging core block pairs into an annular shape such that circumferential side surfaces of circular arc-shaped core back portions contact each other, the core block pairs being configured by stacking together core blocks so as to be spaced apart axially, the core blocks including the core back portions and the teeth, which protrude radially inward from inner circumferential surfaces of the core back portions. The permanent magnets are each configured so as to be divided into a plurality of magnet blocks that are held between the core block pairs so as to fit inside the core block pairs, and the magnet blocks include a base portion that is held between the core back portions, and that has an external shape in which two circumferential side surfaces are positioned circumferentially inside two circumferential side surfaces of the core back portions.

### Effects of the Invention

According to the present invention, the two side surfaces of the base portions of the magnet blocks that are sandwiched between the core back portions are positioned circumferentially inside the two side surfaces of the core back portions. Thus, contact between circumferentially adjacent magnet blocks is avoided when the first and second stator cores are produced by arranging and integrating the core block pairs that hold the magnet blocks such that the circumferential side surfaces of the core back portions are butted against each other. Thus, the occurrence of cracking or chipping of the magnet blocks is suppressed.

### BRIEF DESCRIPTION OF THE DRAWINGS

FIG. 1 is a partially cut away oblique projection that shows an overall configuration of a magnetic inductor electric motor according to Embodiment 1 of the present invention;

FIG. 2 is an oblique projection that shows a core block pair that is arranged so as to line up in an axial direction in the magnetic inductor electric motor according to Embodiment 1 of the present invention;

FIG. 3 is an oblique projection that shows a magnet block in the magnetic inductor electric motor according to Embodiment 1 of the present invention;

FIG. 4 is an oblique projection that shows a state in which three core block pairs are arranged in a magnetic inductor electric motor according to Embodiment 2 of the present invention;

FIG. 5 is an oblique projection that shows adjacent core block pairs in the magnetic inductor electric motor according to Embodiment 2 of the present invention when viewed from radially inside;

FIG. 6 is a schematic diagram that shows adjacent core block pairs in the magnetic inductor electric motor according to Embodiment 2 of the present invention when viewed from radially inside;

FIG. 7 is a schematic diagram that shows adjacent core block pairs in a magnetic inductor electric motor according to Embodiment 3 of the present invention when viewed from radially inside; and

FIG. 8 is a partial oblique projection that shows a stator core in a magnetic inductor electric motor according to Embodiment 4 of the present invention.

### DESCRIPTION OF EMBODIMENTS

Preferred embodiments of the magnetic inductor electric motor according to the present invention will now be explained with reference to the drawings.

### Embodiment 1

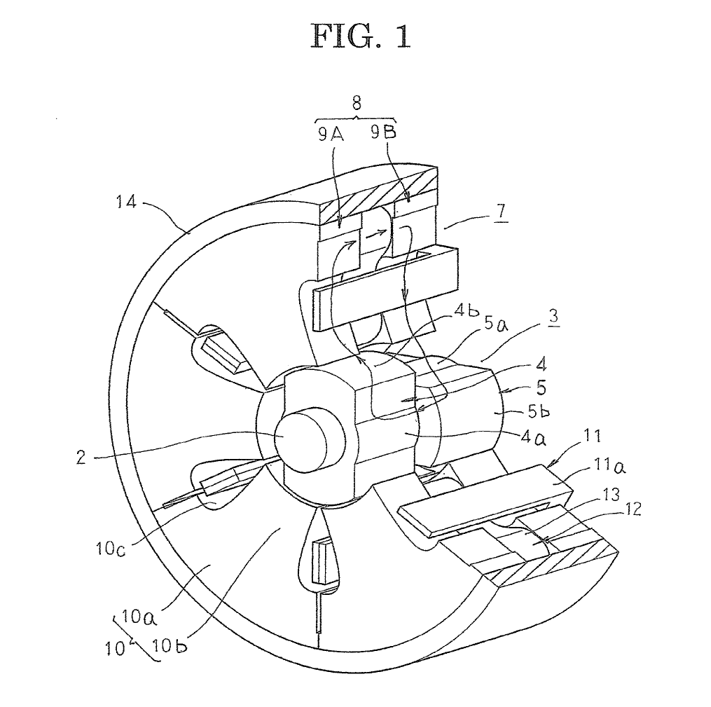

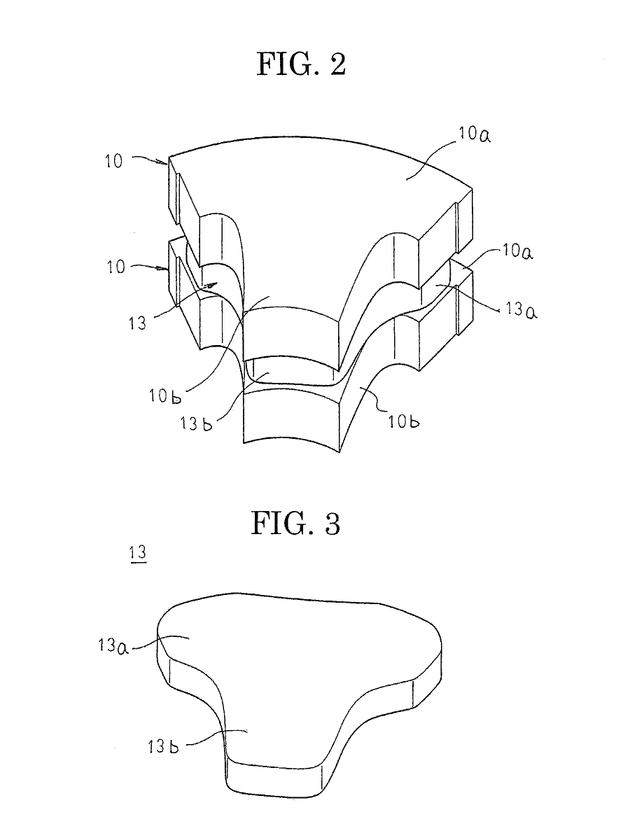

FIG. 1 is a partially cut away oblique projection that shows an overall configuration of a magnetic inductor electric motor according to Embodiment 1 of the present invention, FIG. 2 is an oblique projection that shows a core block pair that is arranged so as to line up in an axial direction in the magnetic inductor electric motor according to Embodiment 1 of the present invention, and FIG. 3 is an oblique projection that shows a magnet block in the magnetic inductor electric motor according to Embodiment 1 of the present invention.

In FIG. 1, a magnetic inductor electric motor 1 includes: a rotor 3 that is fixed coaxially to a rotating shaft 2 that is produced using a solid magnetic body of iron, etc.; a stator 7 that is formed by mounting a stator coil 11 that functions as a torque generating driving coil to a stator core 8 that is disposed so as to surround the rotor 3; permanent magnets 12 that function as a field means; and a housing 14 that houses the rotor 3, the stator 7, and the permanent magnets 12.

The rotor 3 includes first and second rotor cores 4 and 5 that are produced by laminating and integrating a large number of magnetic steel plates that are formed into a prescribed shape. The first and second rotor cores 4 and 5 are produced so as to have identical shapes, and are constituted by: cylindrical base portions 4a and 5a through a central axial position of which rotating shaft insertion apertures are disposed; and two salient poles 4b and 5b that project radially outward from outer circumferential surfaces of the base portions 4a and 5a, that are disposed so as to extend axially, and that are disposed at a uniform angular pitch circumferentially.

The first and second rotor cores 4 and 5 are offset circumferentially by a pitch of half a salient pole, so as to be disposed in contact with each other, and so as to be fixed to the rotating shaft 2 that is inserted into their rotating shaft insertion apertures, to constitute the rotor 3. The rotor 3 is rotatably disposed inside the housing 14 such that two ends of the rotating shaft 2 are supported by bearings (not shown).

The stator core 8 includes first and second stator cores 9A and 9B that are produced so as to have identical shapes. The first and second stator cores 9A and 9B include: a cylindrical core back; and six teeth 10b that each project radially inward from an inner circumferential surface of the core back at a uniform angular pitch circumferentially. Slots 10c that have openings on an inner circumferential side are formed by the core back and adjacent teeth 10b. The first and second stator cores 9A and 9B are disposed inside the housing 14 so as to line up in an axial direction such that circumferential positions of the teeth 10b are aligned, so as to be separated axially, and so as to surround the first and second rotor cores 4 and 5, respectively.

The first and second stator cores 9A and 9B are each divided into six equal sections so as to be constituted by six core blocks 10. The core blocks 10 include: a circular arc-shaped core back portion 10a; and a tooth 10b that protrudes radially inward from a circumferentially central position of an inner circumferential surface of the core back portion 10a, and are produced by laminating and integrating a large number of magnetic steel plates that have an approximate T shape. The first and second stator cores 9A and 9B are each configured by arranging six core blocks 10 into an annular shape such that circumferential side surfaces of the core back portions 10a are butted together. The six core back portions 10a are arranged into an annular shape to constitute the core backs of the first and second stator cores 9A and 9B.

The permanent magnets 12 are configured by arranging six magnet blocks 13 in an annular shape circumferentially. As shown in FIG. 3, the magnet blocks 13 are formed into solid bodies that have an approximate T shape that is constituted by: an arc-shaped base portion 13a; and a shaft portion 13b that protrudes radially inward from an inner circumferential surface of the base portion 13a. The magnet blocks 13 are formed so as to have an external shape that does not protrude from the core blocks 10 when stacked on the end surfaces of the core blocks 10 from a direction that is perpendicular to those end surfaces (an axial direction), and so as to have an external shape such that at least two circumferential side surfaces of the base portions 13a are positioned circumferentially inside two circumferential side surfaces of the core back portions 10a.

As shown in FIG. 2, the magnet blocks 13 are held between a pair of core blocks 10 such that the base portions 13a are positioned between the core back portions 10a, and the shaft portion 13b is positioned between the teeth 10b. Here, the magnet blocks 13 are disposed between the pair of core blocks 10 such that the base portions 13a and the shaft portion 13b do not protrude from between the pair of core blocks 10, and the two circumferential side surfaces of the base portions 13a are positioned circumferentially inside the two circumferential side surfaces of the core back portions 10a.

In addition, concentrated winding coils 11a are wound onto the pairs of facing teeth 10b of the pairs of core blocks 10 that hold the magnet blocks 13 from opposite sides. The pairs of core blocks 10 between which the magnet blocks 13 are held, and onto which the concentrated winding coils 11a are mounted, are disposed inside the housing 14 such that six pairs of the core back portions 10a are arranged into an annular shape such that the circumferential side surfaces thereof are butted against each other.

Thus, the stator coil 11 has six concentrated winding coils 11a that are each produced by winding a conducting wire onto teeth 10b that form pairs that face each other axially without spanning the slots 10c. The stator coil 11 is configured into a three-phase alternating-current winding in which the six concentrated winding coils 11a are connected in order of arrangement in the circumferential direction as a U-phase coil, a V-phase coil, a W-phase coil, a U-phase coil, a V-phase coil, and a W-phase coil, for example.

The housing 14 is disposed so as to be in close contact with an outer circumferential surface of the core back of the first stator core 9A and an outer circumferential surface of the core back of the second stator core 9B. The housing 14 is produced using a non-magnetic body, and is configured so as not to short the magnetic paths of the permanent magnets 12.

Next, operation of a magnetic inductor electric motor 1 that is configured in this manner will be explained.

As indicated by arrows in FIG. 1, magnetic flux from the permanent magnets 12 enters the second stator core 9B, flows through the second stator core 9B axially and radially inward, and from a tooth 10b enters the salient pole 5b of the second rotor core 5 that faces the tooth 10b. Then the magnetic flux that has entered the second rotor core 5 flows radially inward through the second rotor core 5, and then a portion thereof flows axially through the base portion 5a of the second rotor core 5, and a remaining portion flows axially through the rotating shaft 2 and enters the first rotor core 4. The magnetic flux that has entered the first rotor core 4 flows radially outward through the first rotor core 4, and enters a tooth 10b of the first stator core 9A from the salient pole 4b. The magnetic flux that has entered the first stator core 9A flows radially outward through the first stator core, and then flows axially through the first stator core 9A, and returns to the permanent magnet 12.

Here, because the salient poles 4b and 5b of the first and second rotor cores 4 and 5 are offset by a pitch of half a salient pole circumferentially, the magnetic flux acts such that North-seeking (N) poles and South-seeking (S) poles are disposed alternately in a circumferential direction when viewed from an axial direction. Torque is generated by passing an alternating current to the stator coil 11 in response to the rotational position of the rotor 3. Thus, the magnetic inductor electric motor 1 operates as a noncommutator motor, and operates magnetically as a four-pole, six-slot permanent-magnet synchronous motor.

According to Embodiment 1, the first and second stator cores 9A and 9B are configured by arranging core blocks 10 that have an approximate T shape that includes a circular arc-shaped core back portion 10a and a tooth 10b into an annular shape such that circumferential side surfaces of the core back portions 10a are butted against each other. Thus, the core back portions 10a of adjacent core blocks 10 contact each other, ensuring circumferential magnetic paths for the magnetic flux that is generated by the stator coil 11.

Because the magnet blocks 13 do not protrude from between the pairs of core blocks 10, and are formed so as to have external shapes in which the side surfaces of the base portions 13a are positioned circumferentially inside the side surfaces of the core back portions 10a, contact between adjacent magnet blocks 13 is avoided when butting the circumferential side surfaces of the core back portions 10a against each other. Thus, the occurrence of cracking or chipping of the magnet blocks 13 that results from contact between the magnet blocks 13 is prevented during assembly of the stator 7. The occurrence of situations such as magnet fragments that arise due to cracking or chipping of the magnet blocks 13 entering a gap between the stator 7 and the rotor 3 and locking the rotor 3 or increasing mechanical loss can thereby be avoided. Furthermore, because there is no deterioration in magnetic characteristics that results from cracking and chipping of the magnet blocks 13, the permanent magnets 12 will not demagnetize irreversibly even if the ambient temperature changes.

Now, because heat due to core loss and copper loss that is generated in the stator 7 and the stator coil 11 is transferred to the housing 14 by means of the core back portions 10a, and is radiated from the housing 14 to coolants such as air and liquid, from a viewpoint of increasing cooling performance, it is desirable to increase contact area between the core back portions 10a and the housing 14.

Holding the stator core 8 firmly on the housing 14 is also important from the viewpoint of suppressing vibration that results from magnetic attraction, etc., that is generated in the stator 7. Thus, it is desirable to increase the rigidity of the stator 7 by forming a cylindrical portion on the housing 14, and fixing the group of pairs of core blocks 10 that are arranged into an annular shape to the cylindrical portion of the housing 14 by press fitting or shrinkage fitting, to increase the fastening force on the group of pairs of core blocks 10.

Moreover, in Embodiment 1 above, the first and second rotor cores are disposed so as to be in contact with each other in an axial direction, but a disk-shaped partitioning wall that is produced using a magnetic material that has an axial width that is approximately equal to an axial width of the magnet blocks, and that has an outside diameter that is approximately equal to an outside diameter of the salient poles of the first and second rotor cores, may be disposed between the first and second rotor cores. Effects such as magnetic saturation being alleviated can be obtained thereby.

In Embodiment 1 above, the magnet blocks 13 are formed so as to have an approximate T shape that is composed of a base portion 13a and a shaft portion 13b, but the magnet blocks are not limited to the approximate T shape, provided that they have at least a base portion 13a that is held between the core back portions 10a. Furthermore, the base portions 13a may be configured as single parts, or may be configured so as to be divided into a plurality of parts.

In Embodiment 1 above, the magnet blocks 13 that are disposed between the pairs of core blocks 10 are formed so as not to protrude from between the pairs of core blocks 10 in the circumferential direction, but the shaft portions 13b of the magnet blocks 13 may protrude from between the teeth 10b in the circumferential direction provided that they do not contact the concentrated winding coils 11a that are wound onto the pairs of teeth 10b of the pairs of core blocks 10. The volume of the shaft portions 13b, i.e., the volume of the magnet blocks 13, is increased thereby, enabling the magnetic forces of the magnet blocks 13 to be increased.

In Embodiment 1 above, fixing of the pairs of core blocks 10 between which the magnet blocks 13 are sandwiched has not been discussed, but the pairs of core blocks 10 between which the magnet blocks 13 are sandwiched may be fixed using fastening forces from the concentrated winding coils 11a that are wound onto the pairs of teeth 10b of the core blocks 10, or may be fixed using a resin, for example.

### Embodiment 2

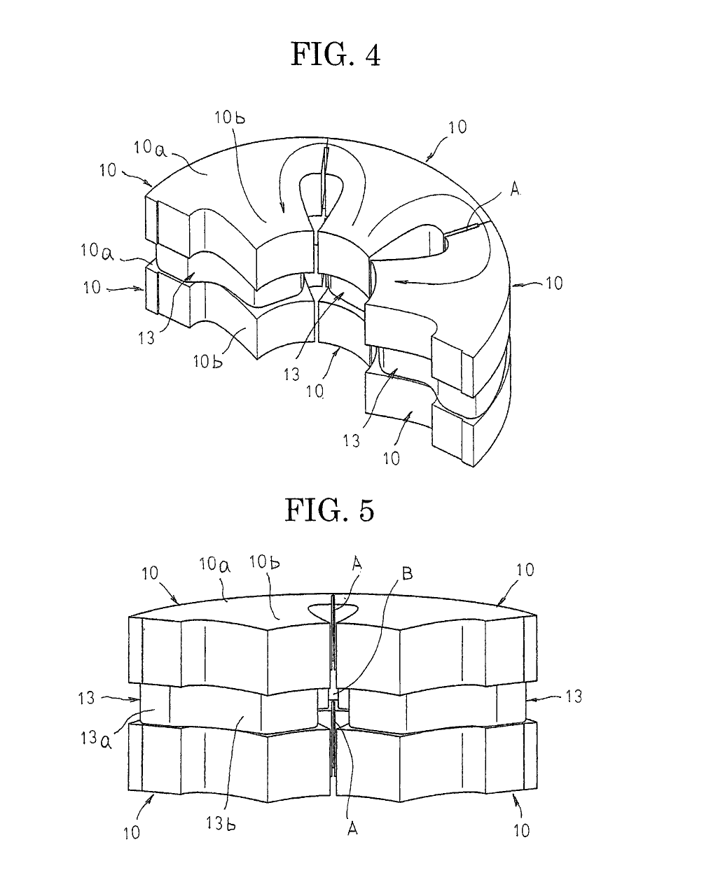

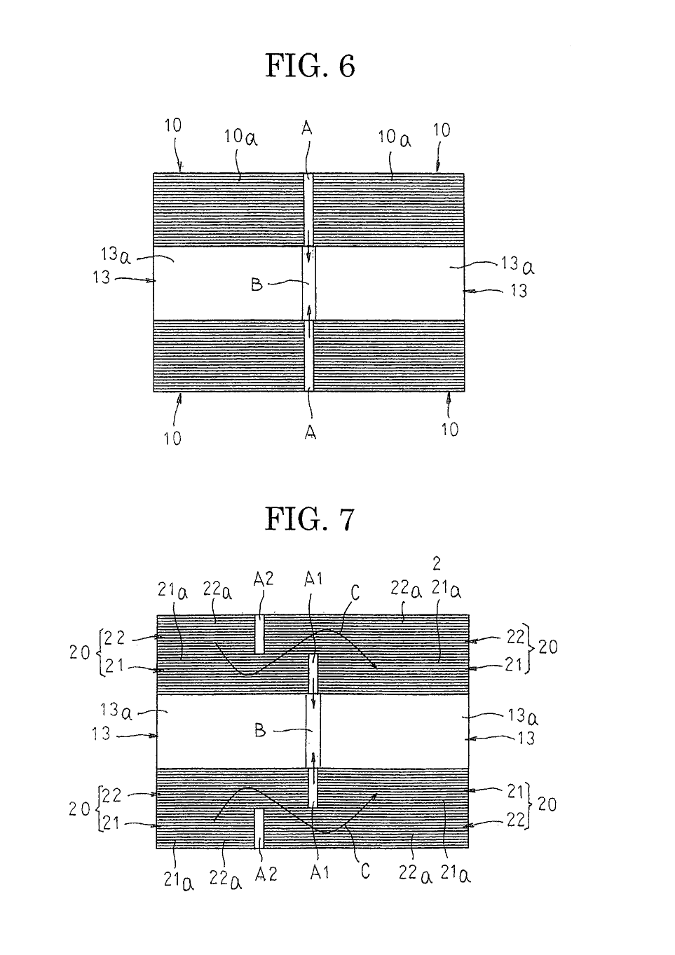

FIG. 4 is an oblique projection that shows a state in which three core block pairs are arranged in a magnetic inductor electric motor according to Embodiment 2 of the present invention, FIG. 5 is an oblique projection that shows adjacent core block pairs in the magnetic inductor electric motor according to Embodiment 2 of the present invention when viewed from radially inside, and FIG. 6 is a schematic diagram that shows adjacent core block pairs in the magnetic inductor electric motor according to Embodiment 2 of the present invention when viewed from radially inside. Moreover, for simplicity, concentrated winding coils are omitted from FIG. 4.

When core blocks 10 are arranged into an annular shape such that side surfaces of core back portions 10a are butted against each other, the side surfaces of the core back portions 10a do not contact completely, but instead contact partially. In Embodiment 2, as shown in FIG. 4, only outer circumferential portions of side surfaces of core back portions 10a contact each other, and portions other than the outer circumferential portions of the side surfaces of the core back portions 10a are separated. Moreover, each of the figures is depicted exaggeratively to show that only outer circumferential sides of the side surfaces of the core back portions 10a contact.

Thus, as indicated by the arrows in FIG. 4, the magnetic flux that is generated by the stator coil 11 flows radially outward through one tooth 10b, branches off and flows to two circumferential sides at the core back portions 10a, flows radially inward through the teeth 10b on the two circumferential sides of the first tooth 10b, enters the first and second rotor cores 4 and 5, and flows from the first and second rotor cores 4 and 5 so as to return to the first tooth 10b. A flow of magnetic flux that flows circumferentially arises thereby, producing a magnetic field in the direction of rotation to obtain a rotational driving force.

Core loss arises as the magnetic flux passes through the core back portions 10a, due to changes being generated in the magnetic flux. The higher the magnetic flux density, the greater the core loss. Because only the outer circumferential portions of the side surfaces of the core back portions 10a contact each other in the butted portions of the core back portions 10a, the magnetic flux density increases abruptly at the contacting portions between the side surfaces of the core back portions 10a, increasing heat generation.

In Embodiment 2, as shown in FIGS. 5 and 6, a gap A is formed on a radially inner side of the contacting portion between the side surfaces of the core back portions 10a, and a gap B is formed between the base portions 13a of circumferentially adjacent magnet blocks 13. A circumferential position of this gap A is aligned with a circumferential position of the gap B between the base portions 13a of the magnet blocks 13. In other words, the magnet blocks 13 are not present in an axial direction of the contacting portion between the side surfaces of the core back portions 10a. Thus, a portion of the heat that is generated at the contacting portion between the side surfaces of the core back portions 10a flows to the housing 14. As indicated by the arrows in FIG. 5, a remaining portion of the heat that is generated at the contacting portion between the side surfaces of the core back portions 10a flows axially through the gaps A and B, and is transferred to the magnet blocks 10 by means of the air inside the gap B. Because the heat that is generated at the contacting portion between the side surfaces of the core back portions 10a is transferred in this manner to the magnet blocks 13 by means of air, which has low thermal conductivity, temperature increases in the magnet blocks 13 are suppressed, enabling an electric motor to be achieved that is less likely to demagnetize thermally, and that is resistant to performance degradation.

Now, in Embodiment 2, the side surfaces of the base portions 13a of the magnet blocks 13 are positioned circumferentially inside the side surfaces of the core back portions 10a, but outer circumferential surfaces of the base portions 13a may additionally be positioned radially further inward than outer circumferential surfaces of the core back portions 10a. When the stator 7 is housed inside the housing 14, ventilating channels are formed thereby between the pair of core blocks 10 that are separated axially, that flow through radially outward on a first circumferential side of the base portions 13a of the magnet blocks 13, that flow between the base portions 13a and the housing 14 to a second circumferential side, and that flow through radially inward on the second circumferential side of the base portions 13a. Thus, airflow that originates from the salient poles 4b and 5b due to rotation of the rotor 3 flows through the above-mentioned ventilating channels, and cools the magnet blocks 13 effectively, enabling temperature increases in the magnet blocks 13 to be suppressed.

In Embodiments 1 and 2 above, the teeth 10b protrude radially inward from circumferentially central positions of inner circumferential surfaces of the core back portions 10a, but the protruding positions of the teeth 10b from the inner circumferential surfaces of the core back portions 10a may be displaced circumferentially from the circumferentially central positions of the core back portions 10a.

### Embodiment 3

FIG. 7 is a schematic diagram that shows adjacent core block pairs in a magnetic inductor electric motor according to Embodiment 3 of the present invention when viewed from radially inside.

In FIG. 7, core blocks 20 are divided into two segments axially, i.e., a first core block segment 21 and a second core block segment 22. In a similar or identical manner to the core blocks 10, the first core block segment 21 includes: a circular arc-shaped core back portion 21a; and a tooth that protrudes radially inward from a circumferentially central position of an inner circumferential surface of the core back portion 21a (not shown). The second core block segment 22 includes: a circular arc-shaped core back portion 22a; and a tooth that protrudes radially inward from a position that is displaced in a first circumferential direction from a circumferentially central position of an inner circumferential surface of the core back portion 22a (not shown). Here, external shapes of the core back portions 21a and 22b of the first and second core block segments 21 and 22 are similar or identical, and external shapes of the teeth are similar or identical.

The core blocks 20 are produced by stacking the teeth and laminating and integrating the first and second core block segments 21 and 22. In the core blocks 20 that are produced in this manner, the core back portions 22a are displaced to a first circumferential side relative to the core back portions 21a.

Pairs of core blocks 20 are produced by stacking the core blocks 20 axially such that a magnet block 13 is held between the first core block segment 21, and concentrated winding coils are mounted onto pairs of teeth that face each other axially. Then, six pairs of core blocks 20 are arranged into an annular shape such that circumferential side surfaces the core back portions 21a are butted against each other, and such that circumferential side surfaces of the core back portions 22a are butted against each other, to constitute a stator.

In a stator that is configured in this manner, as shown in FIG. 7, circumferential positions of the gaps A1 that are formed on the radially inner sides of the butted portions between the circumferential side surfaces of the core back portions 21a are aligned with a circumferential position of the gap B between the base portions 13a of the magnet blocks 13. Circumferential positions of the gaps A2 that are formed on the radially inner sides of the butted portions between the circumferential side surfaces of the core back portions 22a are displaced to the first circumferential side relative to the circumferential positions of the gaps A1 that are formed on the radially inner sides of the butted portions between the circumferential side surfaces of the core back portions 21a.

Moreover, the rest of the configuration is formed in a similar or identical manner to that of Embodiment 2 above.

In Embodiment 3, because axial positions of the gaps A1 that are formed on the radially inner sides of the butted portions between the circumferential side surfaces of the core back portions 21a are aligned with a circumferential position of the gap B between the base portions 13a of the magnet blocks 13, heat that is generated at the circumferential side surfaces of the core back portions 21a due to core loss is also less likely to be transmitted to the magnet blocks 13, in a similar or identical manner to Embodiment 2 above, making the magnet blocks 13 less likely to demagnetize thermally.

According to Embodiment 3, circumferential positions of the gaps A2 that are formed on the radially inner sides of the butted portions between the circumferential side surfaces of the core back portions 22a are displaced to the first circumferential side relative to the circumferential positions of the gaps A1 that are formed on the radially inner sides of the butted portions between the circumferential side surfaces of the core back portions 21a. Thus, because the magnetic flux that flows through the core back portions 21a and 22a flows axially between the gaps A1 and A2, as indicated by arrows C in FIG. 7, the magnetic flux density of the magnetic paths that flow through the core back portions 21a and 22a is reduced, and the amount of change in the magnetic flux is also reduced. Because core loss is reduced thereby, reducing the amount of heat generated, the magnet blocks 13 are even less likely to demagnetize thermally. Because the magnetic resistance of the magnetic paths that flow through the core back portions 21a and 22a is reduced, and the amount of magnetic flux that flows through the core back portions 21a and 22a is increased, a high-output electric motor can be achieved.

Moreover, in Embodiment 3 above, core blocks are configured by laminating two core block segments axially, but the number of axial segments of the core blocks is not limited to two, and may be three or more. In that case, the core block segments that are axially adjacent are produced so as to have different amounts of circumferential protrusion of the core back portions from the teeth. Furthermore, the magnet blocks are formed so as to have an external shape that conforms to an external shape of the block segments between which they are held.

### Embodiment 4

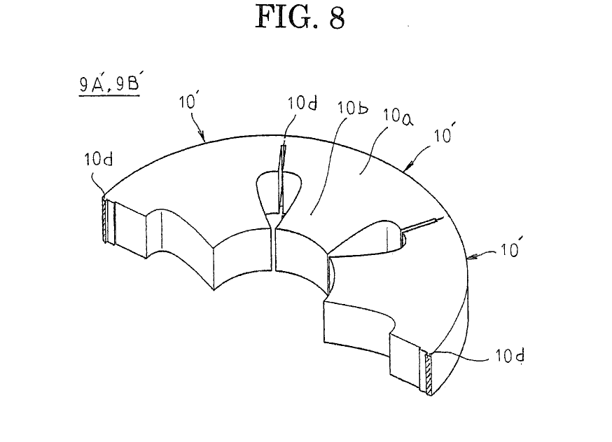

FIG. 8 is a partial oblique projection that shows a stator core in a magnetic inductor electric motor according to Embodiment 4 of the present invention.

In FIG. 8, first and second stator cores 9A′ and 9B′ are each configured such that six core blocks 10′ that are linked continuously by linking together outer circumferential portions of circumferential side portions of core back portions 10a at thin portions 10c that function as bending facilitating portions are produced so as to have an annular shape by bending at the thin portions 10c.

Moreover, Embodiment 4 is configured in a similar or identical manner to Embodiment 1 above except that the six core blocks 10′ are linked continuously at the thin portions 10c.

In Embodiment 4, core block groups in which six core blocks 10′ are linked continuously by thin portions 10c are produced by punching out strip-shaped bodies in which six approximately T-shaped magnetic steel sheet segments are linked continuously by thin segments from a thin sheet of magnetic steel material, for example, and laminating and integrating a number of the strip-shaped bodies, the thin portions 10c, which are constituted by laminating the thin segments, being bendable.

Then, two core block groups that are opened out rectilinearly are stacked such that magnet blocks are disposed between each of the core back portions 10a, concentrated winding coils are mounted onto each of the pairs of teeth 10b, and then the pair of groups of core blocks 10′ are formed into an annular shape by bending at the thin portions 10c, to produce the first and second stator cores 9A′ and 9B′ in which the magnet blocks are sandwiched between the core blocks 10′. Then, the first and second stator cores 9A′ and 9B7 that are formed by bending into an annular shape are fixed to a cylindrical portion of a housing by press fitting or shrinkage fitting, to obtain a stator that is held by the housing. In this case, the thin portions 10c constitute contacting portions between at least the side surfaces of circumferentially adjacent core back portions 10a.

According to Embodiment 4, because the core back portions 10a of the adjacent core blocks 10′ are linked together by means of the thin portions 10c, circumferential magnetic paths for the magnetic flux that is generated by the stator coil are ensured. The magnet blocks are also disposed between the pairs of core blocks 10′ so as not to protrude from between the pairs of core blocks 10′, in a similar or identical manner to Embodiment 1 above. Thus, similar effects to those in Embodiment 1 above can also be achieved in Embodiment 4.

Moreover, in Embodiment 4 above, the six core blocks 10′ are configured continuously by linking together the core back portions 10a using the thin portions 10c, but the bending facilitating portions that link the core back portions together are not limited to thin portions, provided that they are mechanisms that are easily bent. If, for example, the core blocks are configured by laminating magnetic steel sheet segments, then interfitting apertures may be formed in the magnetic steel sheet segments of first core blocks, shaft portions formed in the magnetic steel sheet segments of second core blocks, and adjacent core blocks linked so as to be pivotable around the shaft portions by fitting the shaft portions fitted into the interfitting apertures. In that case, the interfitting portions between the interfitting apertures and the shaft portions constitute the bending facilitating portions.

1: A magnetic inductor electric motor comprising:
a housing that is produced using a nonmagnetic material;
a stator comprising:
a stator core that is configured such that a first stator core and a second stator core that are produced so as to have identical shapes in which teeth that form slots that have openings on an inner circumferential side are disposed at a uniform angular pitch circumferentially so as to project radially inward from an inner circumferential surface of a cylindrical core back are disposed coaxially so as to be separated axially and such that circumferential positions of said teeth are aligned; and
a plurality of coils that are produced by winding a conductor wire onto respective pairs of said teeth of said stator core that face each other axially using a concentrated winding method,
said stator being disposed inside said housing;
a rotor in which a first rotor core and a second rotor core that are produced so as to have identical shapes in which salient poles are disposed so as to project at a uniform angular pitch circumferentially on an outer circumferential surface of a cylindrical base portion are fixed coaxially to a rotating shaft such that said first rotor core is positioned on an inner circumferential side of said first stator core and said second rotor core is positioned on an inner circumferential side of said second stator core, and such that said first rotor core and said second rotor core are offset circumferentially by a pitch of half a salient pole from each other, said rotor being disposed rotatably inside said housing; and
permanent magnets that are disposed between said first stator core and said second stator core, and that generate field magnetic flux such that said salient poles of said first rotor core and said salient poles of said second rotor core have different polarity,
wherein:
said first stator core and said second stator core are configured by arranging core block pairs into an annular shape such that circumferential side surfaces of circular arc-shaped core back portions contact each other, said core block pairs being configured by stacking together core blocks so as to be spaced apart axially, said core blocks comprising said core back portions and said teeth, which protrude radially inward from inner circumferential surfaces of said core back portions;
said permanent magnets are each configured so as to be divided into a plurality of magnet blocks that are held between said core block pairs so as to fit inside said core block pairs; and
said magnet blocks comprise a base portion that is held between said core back portions, and that has an external shape in which two circumferential side surfaces are positioned circumferentially inside two circumferential side surfaces of said core back portions.

2: The magnetic inductor electric motor according to claim 1, wherein said first stator core and said second stator core are each configured by linking said core blocks continuously such that said core back portions are linked at bending facilitating portions.

3: The magnetic inductor electric motor according to claim 1, wherein:
said core blocks are configured by stacking together a plurality of core block segments axially; and
said core block segments that are axially adjacent are configured so as to have different amounts of circumferential protrusion of said core back portions from said teeth.

4: The magnetic inductor electric motor according to claim 1, wherein said core blocks are configured by laminating magnetic steel sheets.
